(19) United States
(12) Patent Application Publication
(10) Pub. No.: US 2026/0359752 A1
(43) Pub. Date: Nov. 12, 2026

(54) Generating a Plan using Collaborating Global and Local Planning Models

(71) Applicant: Microsoft Technology Licensing, LLC, Redmond, WA (US)

(72) Inventors: Tianyi CHEN, Kenmore, WA (US); Ran GAL, Redmond, WA (US); Sara ABDALI, Seattle, WA (US); Saeed AMIZADEH, Seattle, WA (US); Colby Richard BANBURY, Somerville, MA (US); Mohsen FAYYAZ, Berlin (DE); Ruomei YAN, Cambridge (GB)

(73) Assignee: Microsoft Technology Licensing, LLC, Redmond, WA (US)

(21) Appl. No.: 19/199,668

(22) Filed: May 6, 2025

(51) Int. Cl. G06Q 10/0631; G06F 9/451; G06F 16/338; G06F 40/35

(52) U.S. Cl. CPC G06Q 10/06316; G06F 9/451; G06F 9/453; G06F 40/35; G06F 16/338

(57) ABSTRACT

A computer-implemented technique is described that leverages a collaborative interaction between two machine-trained models (“models”) that performs planning using different respective scopes. The first model is a global planning model that generates a global reference plan that specifies a complete set of actions to perform a task. The second model is a local planning model that serially generates actions in a local plan as guided by a current global reference plan. The technique directs the global planning model to generate another global reference plan when an irrecoverable failure is encountered in executing the local plan (based on the first-specified global reference plan). The local planning model subsequently continues its serial generation of actions based on the new global reference plan. A collaboration planning system that includes the local planning model and the global planning model is small enough for successful implementation by a user computing device.

### BACKGROUND

Machine-trained models (“models”) have been successfully trained to generate actions plans. Given a request that describes a desired task, a generated plan specifies how to perform the task in a sequence of one or more actions. There have been continued efforts to improve the accuracy and versatility of these types of models. These efforts have led to the production of increasingly larger planning models (where the number of machine-trained parameters used by a model in the inference stage is often defined as its size). Some local computing devices do not have enough memory, processor, and power resources to feasibly store and run these large models. Cloud-implemented machine-trained models are one solution to this problem. But a network connection is not always available to a local computing device. Further, users may be reluctant to interact with online services due to privacy concerns, particularly in those cases in which the requested tasks are personal in nature.

### SUMMARY

A computer-implemented technique is described that leverages a collaborative interaction between two machine-trained models (“models”) that perform planning using different respective scopes. The first model is a global planning model that generates a global reference plan that specifies a complete set of actions to perform a task. The second model is a local planning model that serially generates actions in a local plan as guided by a current global reference plan. The technique directs the global planning model to generate another global reference plan when a failure is encountered in executing the local plan. The local planning model subsequently continues its serial generation of actions based on the new global reference plan.

The technique is technically advantageous because it synergistically combines the strengths of the two different planning models and offsets their respective weaknesses, resulting in a combined collaboration planning system that is more resilient and accurate than any single model operating by itself. This collaborative approach is capable of being performed by smaller collaborating models, compared to a single model that has been trained to perform all planning functions in a single integrated flow. The smaller models consume fewer resources than a larger integrated model. This enables the collaboration planning system to be successfully implemented by local computing devices (e.g., user computing devices).

The above-summarized technology is capable of being manifested in various types of systems, devices, components, methods, computer-readable storage media, data structures, graphical user interface presentations, articles of manufacture, and so on.

This Summary is provided to introduce a selection of concepts in a simplified form; these concepts are further described below in the Detailed Description. This Summary is not intended to identify key features or essential features of the claimed subject matter, nor is it intended to be used to limit the scope of the claimed subject matter.

### BRIEF DESCRIPTION OF DRAWINGS

FIG. 1 shows a collaborative planning strategy for generating a plan using the cooperative interaction between two machine-trained models (“models”) having different respective planning scopes.

FIG. 2 shows an overview of the collaborative planning system that uses the collaborative planning strategy of FIG. 1.

FIG. 3 shows one implementation of the collaborative planning system of FIG. 2.

FIGS. 4-6 show three examples of the operation of the collaborative planning system of FIGS. 2 and 3.

FIGS. 7-9 show training systems for performing different phases of training in the training of the models used by the collaborative planning system of FIGS. 2 and 3.

FIG. 10 shows additional details regarding the training systems of FIGS. 7-9.

FIG. 11 shows one implementation of an encoder system, which is a part of the collaborative planning system of FIGS. 2 and 3.

FIG. 12 shows one implementation of a language model which is used to implement at least some of the models in the collaborative planning system of FIGS. 2 and 3.

FIG. 13 is a flowchart that provides an overview of one manner of operation of the collaborative planning system of FIGS. 2 and 3.

FIG. 14 is a flowchart that provides additional details regarding the implementation of one of the operations of FIG. 13.

FIG. 15 shows computing equipment that, in some implementations, is used to implement of the computing systems illustrated in the foregoing drawings.

FIG. 16 shows an illustrative type of computing system that, in some implementations, is used to implement any aspect of the features shown in the foregoing drawings.

The same numbers are used throughout the disclosure and figures to reference like components and features.

### DETAILED DESCRIPTION

### A. Collaborative Planning System

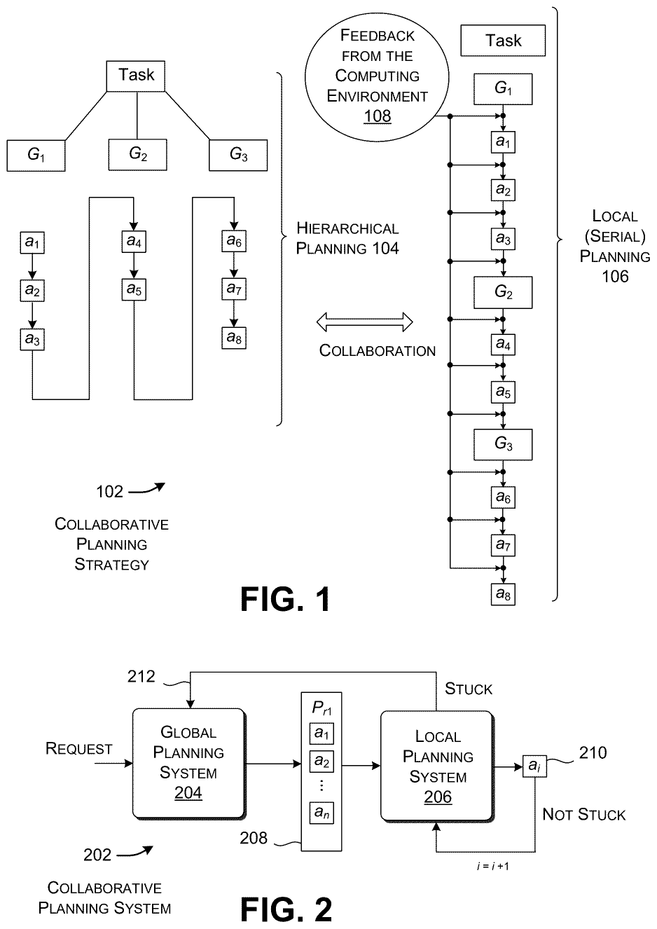

FIG. 1 shows a collaborative planning strategy 102 for generating a plan using the cooperative interaction between two machine-trained planning models (“models”) having different respective planning scopes. A global planning model produces a global plan to complete a specified task. A local plan model serially produces a local plan to complete a specified task. The qualifiers “global” and “local” are intended to indicate that these models generate actions based on different scopes of context, with a “global” context being more encompassing (that is, broader) than a “local” context. For example, the global model produces a global plan based on a consideration of all of the proposed actions in a plan or a substantial specified portion thereof. The local model serially generates individual actions or subsets of actions based on a narrower focus on what actions are most appropriate in view a current state in the generation of the local plan. The best action or subset of actions chosen by the local model will depend on the opportunities and constraints presented to it at this juncture in time.

The left side of FIG. 1 shows an example of hierarchical planning 104 performed by one implementation of a global model. In a first stage, the global model first identifies a set of three sub-goals (G₁, G₂, G₃) that associated with a requested task. In a second stage, the global model identifies subsets of one or more actions that should be performed to accomplish each sub-goal. For example, for the first sub-goal (G₁), the global model identifies three actions (a₁, a₂, a₃) to be performed before advancing to the two actions of the second sub-goal (G₂). The hierarchical planning 104 may also be referred to as “decompose-first” planning because it starts with analysis of the structure of the overall plan.

The right side of FIG. 1 shows an example of local or serial planning 106. Here, the local model successively generates individual actions in a local plan. Alternatively, or in addition, the local model successively generates groups of individual actions (such as subsets of two or three individual actions). As a condition for advancing to a next action, the local model performs a check based on environmental feedback 108. In some examples, the environmental check includes executing an action and determining whether the action produces a desired result. In some implementations, the environmental check also includes grounding analysis performed by a local grounding component, e.g., for the purpose of identifying a location of a user interface element involved in the action.

Other implementations of the collaborative strategies use other variations of global and local planning. In all such variations, the global planning performs analysis having a wider scope compared to the local planning.

FIG. 2 shows a high-level view of a collaborative planning system 202 that leverages the productive interaction between global and local planning. The collaborative planning system 202 includes a global planning system 204 for performing the global planning and a local planning system 206 for performing the local planning. The global planning system 204 uses a global model (not shown) while the local planning system 206 uses a local model (not shown). In operation, based on a submitted request, the global planning system 204 generates a first global reference plan 208. The global reference plan 208 identifies a complete set of actions (a₁-aₙ) to be performed in accomplishing the task, or a substantial portion of the complete set of actions. The local planning system 206 serially generates individual actions (or subsets of actions) in a first local plan, as guided by the actions specified in the first global reference plan 208. Action at 210 is one such action generated by the local planning system 206 at a particular juncture in the generation of the first local plan.

More specifically, the qualifier “reference” in the term “global reference plan” indicates that the actions in the global reference plan 208 serve as a reference that guides the choice of actions in the first local plan. However, although the local planning system 206 may start by selecting the first action in the first global reference plan, it is not thereafter forced to choose the suggested actions in the first global reference plan. For example, the local planning system 206 may choose to invoke a different action than a suggested action upon concluding that the suggested action will not lead to a favorable outcome. The local planning system 206 is able to reach this conclusion because it has better and more immediate insight into the real-time feasibility of different actions (due the environmental feedback 108 illustrated in FIG. 1).

In other circumstances, the local planning system 206 determines that it has reached an impasse in the first local plan and cannot choose a suitable next action to escape this condition. In this case, the local planning system 206 asks the global planning system 204 to generate a new (second) global reference plan which differs from the first global reference plan 208. FIG. 2 illustrates this branch in processing as path 212. Thereafter, the global planning system 204 uses the second global reference plan as non-binding guidance in completing the task. The task is completed from either a point of failure of the first local plan or from an earlier point (and possibly a first action a₁ in completing the task).

The difference between a global plan and a local plan may be metaphorically likened to long-term and short-term travel plans generated by hypothetical global and local routing algorithms. The global routing algorithm may generate a global travel plan for an entire trip based on global consideration available to it. A local routing algorithm generates a local travel plan based on both the global travel plan and based on its knowledge of opportunities and constraints in the immediate surrounding (e.g., within a radius of twenty miles). The local routing algorithm may choose to adhere to the global travel plan. But it remains free to deviate from this global travel plan if circumstances warrant (such as when a road closure or traffic jam is encountered). Alternatively, the local routing algorithm may ask the global routing algorithm to generate a new global travel plan because its local analysis has become unreliable and untethered from the ultimate goal of the trip.

Like the analogy to hypothetical and metaphorical routing systems, the global planning system 204 and the local planning system 206 of FIG. 2 have respective strengths and weaknesses. The global planning system 204 is better at considering long-term opportunities and constraints than the local planning system 206. But the global planning system 204 does not have immediate knowledge of the constraints and opportunities that will be actually faced in the execution of the global reference plan. The strengths and weaknesses are reversed for the case of the local planning system 206: it has superior insight into what action is best at a given juncture in the execution of a local plan, but may lack the type of global insight available to the global planning system 204. Acting separately, the global planning system 204 and the local planning system 206 are susceptible to different kinds of failures. For example, the local planning system 206 is susceptible to failures that occur when execution enters endless processing loops. The global planning system 202 is susceptible to failures that result in unforeseen local conditions in the execution of a plan.

The combination of the global planning system 204 and the local planning system 206, on the other hand, produces a collaborative planning system 202 that has greater resilience against failure than either system operating alone. This is because the strengths and weaknesses of the two planning systems (204, 206) productively complement each other. Further, this increased accuracy and resilience is achieved by using a relatively resource-efficient global model and local model. For example, the total number of parameters used by both global and local models (when combined) is less than some other planning models that rely on integrated processing flows to address the myriad issues that may arise in planning. This enables the collaborative planning system 202 to successfully run on a local computing system (e.g., a user computing device) having limited resources (compared to a server system, for instance). However, any aspect of the collaborative planning system 202 can alternatively run on a server system, in whole or in part.

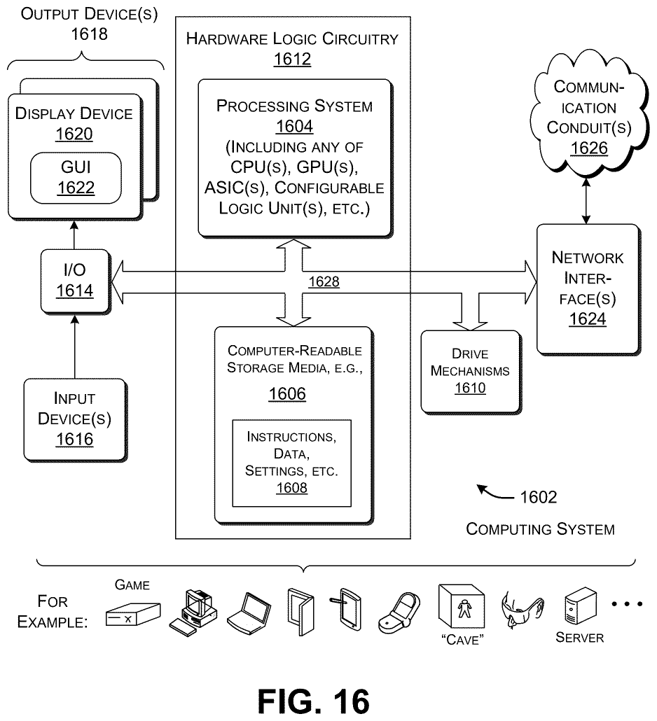

With the above introduction, illustrative details of the collaborative planning system 202 are set forth below. The following terminology is relevant to some examples presented below. A “machine-trained model” or “model” refers to computer-implemented logic for executing a task using machine-trained weights that are produced in a training operation. A language model is a specific type of machine-trained model that is trained, in part, to predict a next token given a series of tokens which precede the predicted token. A “parameter” refers to any type of parameter value (e.g., a weight value or a bias value) that is iteratively produced by the training operation. A “token” refers to a unit of information processed by a machine-trained model, such as a word or a part of a word. In some cases, a tokenizer produces the tokens, but an item (e.g., a text passage) is said to be composed of tokens in a general sense (in which “token” is a synonym of “part”), irrespective of when and where those tokens are actually produced. A “prompt” refers to a sequence of tokens submitted to a machine-trained model. A “distributed vector” or “embedding” expresses the semantic content of an information item by distributing information over its k dimensions. In some contexts, terms such as “component,” “module,” “engine,” and “tool” refer to parts of computer-based technology that perform respective functions. FIGS. 15 and 16, described below, provide examples of illustrative computing equipment for performing these functions

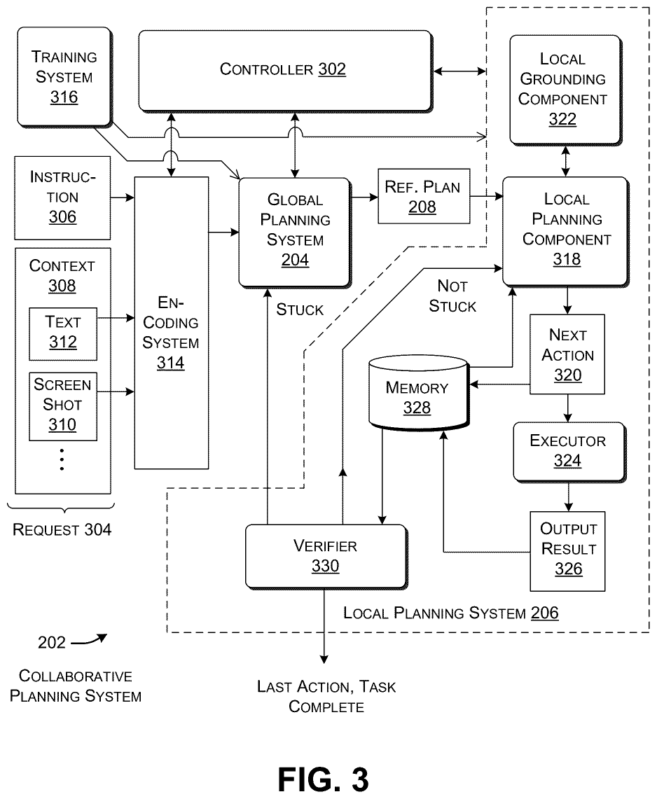

FIG. 3 shows one implementation of the collaborative planning system 202 of FIG. 2. As described above, the collaborative planning system 202 includes a global planning system 204 for generating a global reference plan 208, and a local planning system 206 for serially generating actions or subsets of actions in a local plan. The local planning system's choice of actions is guided by the non-binding suggestions of actions in the global reference plan. A controller 302 manages or orchestrates all of the operations performed by the collaborative planning system 202. In some implementations, the controller 302 is a control program that embodies environment-specific heuristics.

Different processing environments are capable of applying the collaborative planning system 202 to serve different respective objectives. In the examples emphasized herein, a user of a local computing system uses the collaborative planning system 202 to automatically generate a plan for executing a requested task. The computing system can be configured to automatically perform the generated plan or to perform the plan upon the explicit approval of the user. For example, the computing system automatically generates plans for some types of tasks (e.g., those pertaining to browser searches), but waits for confirmation for tasks that can have negative consequences if executed incorrectly (e.g., e.g., those pertaining to generating and sending an email message or the transfer of funds). Illustrative tasks for which a user may wish to engage the collaborative planning system 202 include: a) changing a control setting; b) creating a table in a word processing program; c) creating an email; d) filtering a collection of files in a folder, and so on. Alternatively, or in addition, a user may instruct the collaborative planning system to perform a task that involves interacting with an online service or application. Illustrative tasks of this type include: a) cancelling a subscription; b) changing a social media profile; c) changing a control setting of an online application; d) transferring funds; e) blocking messages sent by an online application, and so on. These use cases are representative; a successful application of the collaborative planning system 202 to a particular task only requires that the collaborative planning system 202 has: a) knowledge of the protocols and interfaces used by a service or application or operating system component that will be used to perform the task; b) the ability effectuate changes to these services, applications, and operating system components; and c) the ability to verify that actions performed by these services, applications, and operating system components are correct.

The collaborative planning system 202 begins by receiving a request 304 that specifies a task to be performed. In some cases, the request 304 includes an explicit instruction 306, such as “please check the files in this folder for viruses.” The collaborative planning system 202 can receive this instruction 306 in any form, such as a textual instruction provided by a text input device, an audio signal provided by a voice recognition component, a selection signal produced as a result of selection in a pre-generated menu of possible requests, and so on. In some implementations, the collaborative planning system 202 also receives context information 308 that helps the collaborative planning system 202 interpret the instruction 306. For example, the context information 308 includes a screen shot 310 of a screen that the user is interacting with at the time of the request 304, or a textual passage 312 with which the user is interacting at the time of making the request 304. In a video playback application, the context information 308 includes the frame and/or audio associated with a particular juncture at which the user made the request 304.

An encoding system 314 includes one or more encoders that encode the information in the request 304 into encoded input information. For example, the encoded input information includes a sequence of embedding vectors in a vector space. Section D provides details regarding an illustrative implementation of the encoding system 314.

The global planning system 204 includes a global model (not shown) that maps the encoded input information to the first global reference plan 208. In some implementations, the global model is a language model that autoregressively produces the first global reference plan 208. Autoregressive means that the language model generates tokens of a response token by token. The input information for any pass (other than the first pass) includes the last-predicted token produced by the last pass appended thereto. Section D provides details regarding one illustrative implementation of a language model.

In some examples, the global reference plan 208 includes a complete set of actions to perform the entire action. In some examples, a training system 316 trains the global planning model to produce a global reference plan by performing a chain of reasoning that includes first identifying sub-goals in the reference plan and then identifying actions in each sub-goal. Note that, although the training system 316 trains the global planning model to “reason” in a sequence of stages, in the inference stage, the global planning model generates its output in an autoregressive manner, token by token, unless explicitly requested to first identify the sub-goals followed by the actions associated with the sub-goals.

The local planning system 206 includes a local planning component 318 that serially generates individual actions or subsets of individual actions in a local plan, as guided by the global reference plan 208. FIG. 3 specifically illustrates a time at which the local planning component 318 generates a next action 320. The local planning system 206 is implemented by a local planning model, which, in some implementations, is another language model. The training system 316 trains the local model to serially generate actions in a local plan, as guided as a global reference plan.

What constitutes “guidance” is different in different implementations of the collaborative planning system 202. In some implementations, the local planning component 318 will choose the first action in the global reference plan as the first action in the local plan being generated. Thereafter, when selecting a next action, the global planning component 318 will consider a range of options, including whatever action is recommended by the global reference plan at this juncture. The global planning model can be configured to choose an option based on levels of confidence associated with different action options (e.g., as reflected by probabilities generated by a Softmax layer of the language model). The global planning model is configured to boost the probability of whatever action has been suggested by the global reference plan by a prescribed amount, such that it will be favored unless there are overriding factors that otherwise reduce its viability relative to other options.

Generally, the local planning component 318 will diverge from the actions in the global reference plan 208 when it discovers that the action will not lead to a desired end result. For instance, the local planning component 318 has knowledge that an operating system will not perform an action in manner proposed by the global reference plan 208 because it has been updated. Only the local planning component 318 is aware of this update.

In some implementations, the local planning component 318 can also consult a local grounding component 322 in deciding an appropriate next action to take. In some processing environments, the grounding component 322 identifies the locations of user interface elements that are involved in performing an action. Consider the case, for instance, in which a proposed action involves selecting a particular user interface element in the course of interacting with a particular application program. The grounding component 322 identifies: a) whether the particular user interface element is actually present in the user interface presentation; and b), if so, the location of the user interface element in the user interface presentation. This analysis constitutes a grounding check. The local planning component 318 uses this feedback to produce an action having an increased probability of success. More generally, the grounding component 322 provides feedback from the environment being controlled that helps assure the local planning component 318 that the action it is choosing is correct. The grounding component 322 performs the above function based on its knowledge of the environment being controlled, e.g., which may be expressed in the weights of a machine-trained model, and/or in a set of rules, and/or in a knowledge base, etc.

An executor 324 executes the next action 320. In some implementations, the executor 324 is an operating system component and/or an application component of the computing system that performs the action 320 (although it could be an online agent that operates in a network environment). For example, for the case in which the action is clicking on a graphical control element, the computing system automatically “clicks” on the graphical element. For the case in which the control action is adjusting the level of a control setting, the computing system automatically adjusts the level of the control setting, and so on. Different implementations of the executor 324 execute actions in different respective modes. In a safe mode, the executor 324 performs the actions in a test framework, without formally committing to any of the changes that are made, until, that is, the user confirms that the changes are acceptable. In a regular (non-test) mode, the executor 324 actually executes the actions. Configuration information specifies which types of tasks are to be performed in the safe mode which actions are allowed to proceed in the regular mode.

The execution of the action 320 produces an output result 326. In some examples, the output result 326 is a change of state in a program being controlled. The change of state may lead to the generation of a confirmation message or a new user interface page. In other examples, the output result 326 is a failure to advance the state of the program being controlled. Such a failure may cause the program to generate an error message, or it may result in no feedback at all (because the program effectively “freezes” up).

A memory 328 stores information regarding the execution of the local plan within a specified context window (e.g., encompassing the last n actions performed). The stored information identifies the current global reference plan, the actions taken so far, the statuses of those actions, etc.

A verifier 330 controls the processing flow of the local planning system 206 based on the status information in memory 328. The verifier 330 includes a program that encodes at least two outcomes. As one outcome, upon concluding that the last action 320 has successfully executed, the verifier 330 directs the local planning component 318 to generate the next action or subset of actions. As another outcome, upon concluding that the last action 320 has not successfully executed, the verifier 330 determines whether the program being controlled is “stuck” or “frozen,” e.g., because it has entered an endless loop or reached some other kind of programmatic impasse. As a first resort, the verifier 330 may instruct the local planning component 318 to choose another action. The temperature parameter of the language model's Softmax layer (used by the local planning component 318) controls, in part, the range of options available to the language model in choosing another action. If this action still fails to advance the program being controlled, then the verifier 330 instructs the global planning system 204 to generate another global reference plan. Thereafter, the local planning system 206 resumes its serial execution of actions, but from this juncture onward, drawing guidance from the second global reference plan.

Different implementations of the verifier 330 use different rules to determine whether to abandon a global reference plan. In some cases, the verifier 330 decides to abandon a global reference plan when the local planning component 318 fails to advance the state of a program being controlled towards the completion of the task in a prescribed number of tries (e.g., 3 tries).

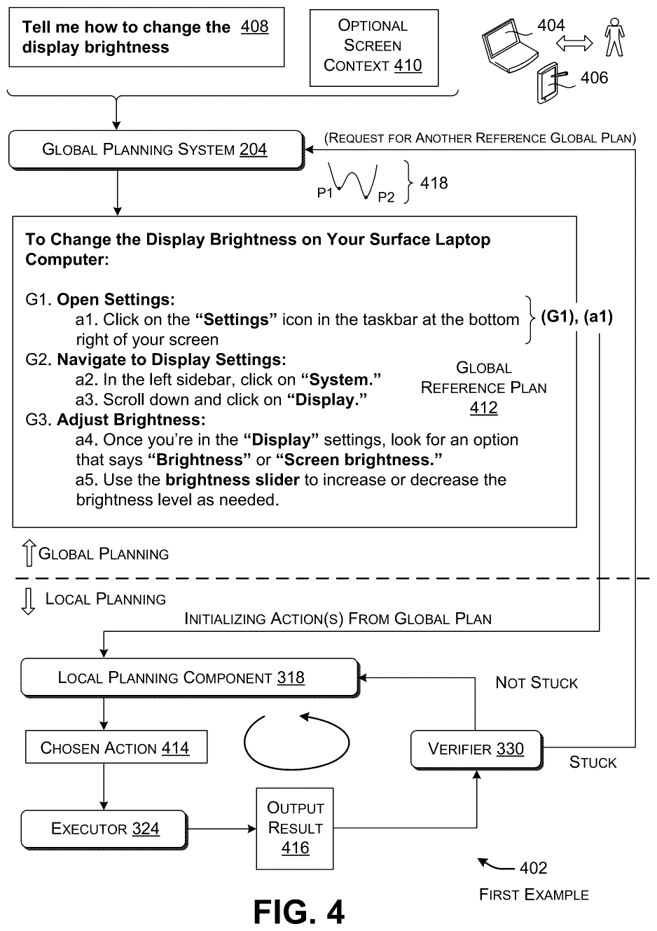

FIGS. 4-6 show three examples of the operation of the collaborative planning system of FIGS. 2 and 3. Beginning with the example 402 of FIG. 4, a user interacts with a user computing device (e.g., device 404 or device 406) and intends to perform a task using the computing device. The collaborative planning system 202 runs on the computing device. Here, the input request includes a textual instruction 408: “Tell me how to change the display brightness.” Optionally, the collaborative planning system 202 also captures a screen shot 410 of the user interface presentations that the user is viewing at the time of making the request.

The encoding system 314 maps the request into encoded information. The global planning system 204 maps the encoded information into a global reference plan 412. The global reference plan 412 identifies a sequence of five suggested actions that will perform the task specified by the request. The global reference plan 412 also groups the five actions into three sub-goals (G₁, G₂, G₃).

The local planning component 318 then serially generates actions or subsets of actions of a local plan, as guided by the global reference plan 412. To begin with, in some implementations, the local planning component 318 chooses the first action specified by the global reference plan 412. More generally, the local planning component 318 chooses a next action 414 or subset of next actions. The executor 324 executes the action 414. For example, for example, the executor 324 clicks on the “Settings” icon in the taskbar at the bottom right the screen. This produces an output result 416. In some examples, the output results result 416 is manifested in a change of state of the program being controlled, which leads to a change in a user interface presentation. The verifier 330 determines, on the basis of at least the output result 416, whether the action 414 was successfully implemented. If deemed a success, the verifier 330 instructs the local planning component 318 to generate a next action or subset of actions. If unsuccessful, the verifier 330 may instruct the local planning component 318 to try another candidate action, or if the program is determined to be “stuck,” instructs the global planning system 204 to generate another global reference plan.

In some implementations, the global planning system 204 selects from a set of viable global reference plans that were generated at the same time as the first global reference plan 412. In other implementations, the global planning system 204 dynamically generates another global reference plan. Different viable global reference plans may ultimately reflect the fact that there are different local minima on which to converge in performing stochastic gradient descent during training. As broadly represented by graph 418, one candidate global reference plan may correspond to one local minimum (P1), and another candidate global reference plan may correspond to another local minimum (P2). Further, the temperature parameter of the language model's Softmax layer (used by the global planning system 204) controls the range of options available to the language model in autoregressively constructing a global reference plan.

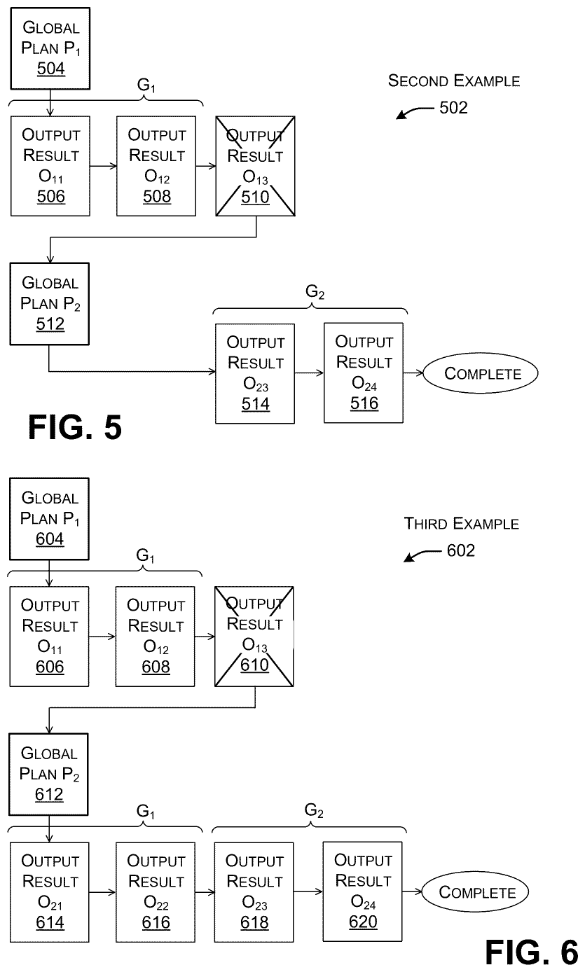

FIGS. 5 and 6 illustrate two different paths by which four actions are executed to perform a task. The first two actions are associated with a first sub-goal (G₁) and the last two actions are associated with a second sub-goal (G₂). Beginning with the example 502 of FIG. 5, the global planning system 204 generates a first global reference plan 504. The local planning component 318 then successfully performs two actions (506, 508) in a local plan, as guided by the first global reference plan 504. The local planning component 318, however, encounters an impasse (e.g., an endless loop) upon executing a third proposed action 510.

The verifier 330 instructs the global planning system 204 to generate a second global reference plan 512. In this illustrative case, the global planning system 204 determines that the next most viable global reference plan includes the same two operations as the first global reference plan 504. As such, upon receiving the second global reference plan 512, the local planning component 318 can begin generating actions starting with a third suggested action 514 in the second global reference plan. The local planning component 318 concludes that the third suggested action 514 successfully executes. Likewise, the local planning component 318 generates a fourth and final action 516, which successfully executes.

The example 602 of FIG. 6 begins in the same way as the example 502 of FIG. 5. That is, the global planning system 204 generates a first global reference plan 604. The local planning component 318 successfully executes the first two actions (606, 608) of a local plan, but execution of third generated action 610 fails.

The verifier 330 again instructs the global planning system 204 to generate another global reference plan 612. In this example, however, the second global reference plan 612 starts from a different initial action compared to the first global reference plan 604. Accordingly, the local planning component 318 will effectively generate a second local plan starting from “scratch,” that is, by beginning with a first action 614 suggested by the second global reference plan 612. In this example, the local planning component 318 successively generates the remaining three actions (616, 618, 620) of the second local plan without encountering a failure.

Generally, different implementations use different heuristics in controlling the interaction between the global planning system 204 and the local planning system 206. FIGS. 5 and 6 illustrate one rule that depends on the extent of overlap in actions between two successively generated global reference plans. Some implementations attempt to ensure that there is diversity among different successively suggested global reference plans. In other circumstances, an implementation may attempt to choose a plan that preserves whatever sub-group of actions have already successfully completed under the guidance of the previous global reference plan.

### B. Training System

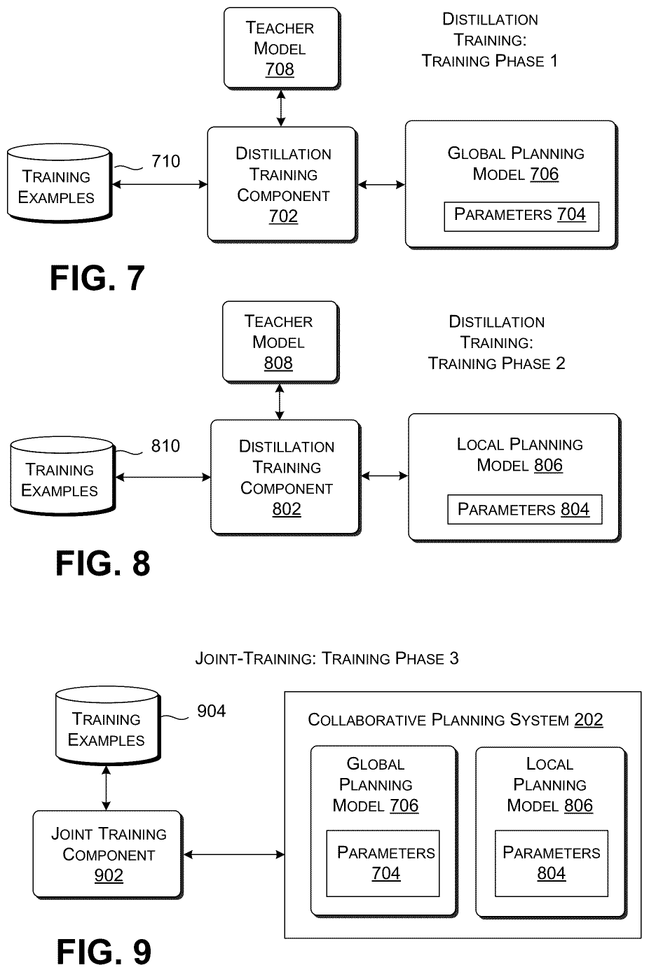

FIGS. 7-9 show training systems for performing different phases of training in the training of the models used by the collaborative planning system 202 of FIGS. 2 and 3. The training system 316 of FIG. 3 provides a framework that performs all of these phases.

Beginning with FIG. 7, a distillation training component 702 trains the parameters 704 of a global planning model 706 (for use in the global planning system 204) using teacher-student knowledge distillation. That is, the distillation training component 702 directs a teacher model 708 to generate teacher-model global reference plans for a set of requests in a data store 710, and directs the global planning model 706 to generate student-model global reference plans for the same set of requests. The distillation training component 702 generates loss information by comparing the teacher-model plans with the student-model plans using any loss function (including cross-entropy, KL divergence, contrastive, etc., or any combination thereof). The distillation training component 702 then updates the parameters 704 of the global planning model 706 using any updating algorithm based on the loss information, such as stochastic gradient descent in combination with back propagation.

One specific type of knowledge distillation that can be used to perform this task is described in co-pending U.S. application Ser. No. 19/025,011 to Ko, et al., filed Jan. 16, 2025, and entitled “Knowledge Distillation using Hybrid Loss Function for Different Sample Types,” which is incorporated herein in its entirety by reference. Contrastive learning involves preparing negative training examples and positive training examples. In the present context, each positive training example includes a valid pairing of a request and a global reference plan, and each negative training examples incudes an invalid (incorrect) pairing of the request and a global reference plan. Training based on a contrastive loss function attempts to progressively increase the extent to which the requests of positive training examples are paired with matching ground-truth global reference plans and decrease the extent to which requests of negative training examples are paired with incorrect global reference plans. In other words, a contrastive loss function pushes positive pairs closer together and negative pairs farther apart as training proceeds.

The teacher model 708 is generally a larger and more powerful language model compared to the global planning model 204 being trained. For example, the teacher model 708 and the global planning model 204 are two models from a same model family having different respective sizes. For example, the publicly available and general purpose LLaMA model is currently available in sizes of 8B, 70B, and 405B parameters.

FIG. 8 shows a distillation training component 802 that trains the parameters 804 of a local planning model 816 (for use in the local planning component 318) using teacher-student knowledge distillation. This training parallels that described above for training the global planning model 706, but is performed separately from that training. That is, the distillation training component 802 directs a teacher model 808 to serially generate teacher-model local reference plans for a set of requests in a data store 810, and directs the local planning model 806 to generate student-model global reference plans for the same set of requests. The distillation training component 802 generates loss information by comparing the teacher-model plans with the student-model plans using any loss function (including cross-entropy, KL divergence, contrastive, etc., or any combination thereof). The distillation training component 802 then updates the parameters 804 of the local planning model 806 using any update algorithm based on the loss information, such as stochastic gradient descent in combination with back propagation. Note that the global planning model 706 and the local planning model 806 generate plans in different ways based on different considerations (as described above), and thus, although the training system 316 may apply the same training techniques to train these models, the models thus produced embody different kinds of knowledge.

FIG. 9 shows a third phase of training performed by a joint training component 902 based on examples in a data store 904. The joint training component 902 performs further training on the parameters (704, 804) of the global planning model 706 and the local planning model 806, respectively. In some examples, the joint training system uses reward-based training to perform this task, such as Proximal Policy Optimization (PPO) or Direct Preference Optimization (DPO). DPO training applies the following loss function:

$${ℒ}_{DPO} ( {π}_{θ} , {π}_{ref} ) = - {𝔼}_{𝒟} [ log σ ( βlog \frac{{π}_{θ} ( {y}_{p} \vert x )}{{π}_{ref} ( {y}_{p} \vert x )} - βlog \frac{{π}_{θ} ( {y}_{n} \vert x )}{{π}_{ref} ( {y}_{n} \vert x )} ) ] . \qquad ( 1 )$$

In the present context, the joint training component 902 selects a positive (yₚ) and negative (yₙ) plan for each request x under consideration, with the positive plan being an accurate plan and the negative plan being an inaccurate plan. The joint training component 902 then uses the collaborative planning system 202 being trained to generate model-generated plans for each of the requests. π_{θ}(yₚ|x) identifies the probability associated with a positive plan yₚ for a request x and π_{θ}(yₙ|x) identifies the probability associated with a negative plan yₙ for the same request x. (Note that the collaborative planning system 202 produces a distribution of probabilities associated with respective plans, and the probabilities of individual plans are obtained from this distribution.) The joint training component 902 then uses the collaborative planning system 202, with its models fixed at their initial state at the start of reinforcement learning, to generate counterpart probabilities (π_{ref}(yₚ|x) π_{ref}(yₙ|x)). That is, the parameters of these models are the same parameters produced by the first two phases of training shown in FIGS. 7 and 8, and are not updated in response to the reinforcement learning. The inclusion of these reference (ref) probabilities in the above equation helps stabilize the reinforcement training, e.g., by preventing it from diverging too far from the knowledge gained through the first two phases of distillation training. σ refers to the logistic sigmoid function, β is an environment-specific hyper-parameter, and [symbol] refers to the set of training examples.

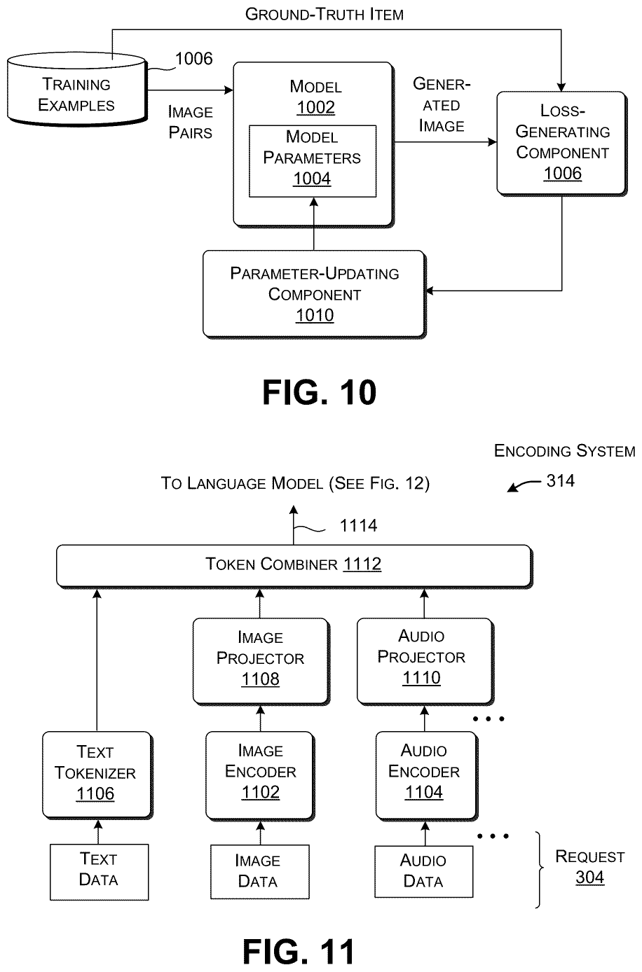

FIG. 10 generalizes any stage of training described above to train a model 1002 having parameters 1004. A loss-generating component 1006 compares model-generated results with ground-truth results associated with training examples in a data store 1008. A parameter-updating component 1010 updates the parameters 1004 of the model 1002 based on the loss information, e.g., using stochastic gradient descent in combination with back propagation.

### C. Illustrative Machine-Trained Models

FIG. 11 shows one implementation of the encoding system 314 introduced in the context of FIG. 3. The function of the encoding system 314 is to convert the different components of the request 304 into encoded information, which is subsequently feed to the global planning model 706.

The encoding system 314 includes an image encoder 1102 for mapping each image (if any) of the request 304 into image tokens. In some examples, the image encoder 1102 breaks an image input image into a series of image patches, such as 16 image patches. The image encoder 1102 then uses any kind of neural network to map the image tokens into respective image embeddings. For example, the neural network is a convolutional neural network (CNN) or a transformer language model. In other examples, the image encoder 1102 uses a CNN (e.g., a ResNet CNN) to map each pixel of an image to an embedding vector.

An optional audio encoder 1104 converts a stream of raw audio data into audio embeddings. For example, the audio encoder 1104 converts the audio data into a stream of audio features, organized into a series of audio frames. For instance, the audio features correspond to Mel-frequency cepstral coefficients (MFCCs). The audio encoder 1104 then maps the audio features into audio embeddings using any kind of neural network. In other examples, the audio encoder 1104 produces a logarithm melspectrogram based on the audio data, and then partitions the melspectrogram into individual patches, akin to the above-summarized case of image processing. The individual patches constitute audio tokens. The audio encoder 1104 then uses any type of neural network (e.g., a transformer-based model) to convert the audio tokens into the audio embeddings. In other examples, the encoding system 314 uses a publicly available speech encoder, such as the WHISPER encoder provided by Open AI of San Francisco, California. In other implementations, a speech-to-text converter first converts the audio data into text data, and then uses a text encoder 1106 to produce the audio embeddings.

The text encoder 1106 maps text data (if used) into text embeddings. The text encoder 1106 performs this task using any tokenizing algorithm, such as the byte pair encoding (BPE), WordPiece, or SentencePiece algorithms. The text encoder 1106 maps codes associated with the text tokens into text embeddings, e.g., using a machine-trained linear transformation. The text embeddings are combined with position information to describe the positions of their corresponding tokens in the input text.

An image projector 1108 maps the vision embeddings produced by the image encoder 1102 into embeddings in the same vector space as the text encoder 1106. Similarly, an audio projector 1110 maps the audio embeddings produced by the audio encoder 1104 into the same vector space as the text encoder 1106. A token combiner 1112 combines the different kinds of tokens together (e.g., via concatenation), to form combined output information 1114. The combined output information 1114 is encoded with position information that describes the position of individual tokens in a sequence of tokens, e.g., by describing the position of a particular image patch within an image.

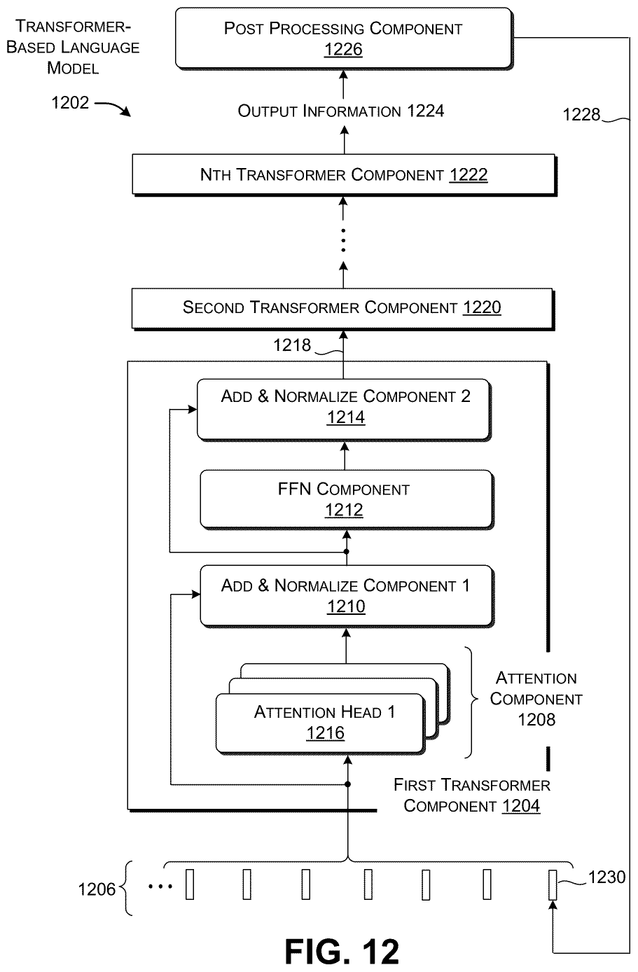

FIG. 12 shows a transformer-based language model (“language model”) 1202. A first trained instance of the language model 1202 implements the global planning model 706. A second trained instance of the language model 1202 implements the local planning model 806. As described above, the global planning model 706 embodies different knowledge and has different parameters than the local planning model 806. The language model 1202 is composed, in part, of a pipeline of transformer components, including a first transformer component 1204. FIG. 12 provides details regarding one way to implement the first transformer component 1204. Although not specifically illustrated, other transformer components of the language model 1202 have the same architecture and perform the same functions as the first transformer component 1204 (but are governed by separate sets of parameters).

The language model 1202 commences its operation with the receipt of input information, including a sequence of embeddings 1206. The input information includes, for the case of the global planning model 706, embeddings associated with the sequence of tokens provided by the encoding system 314 of FIG. 3. The input information includes, for the case of the local planning model 806, embeddings associated with the sequence of tokens in a global reference plan.

The first transformer component 1204 operates on input embeddings 1206 using, in order, an attention component 1208, a first add-and-normalize component 1210, a feed-forward neural network (FFN) component 1212, and a second add-and-normalize component 1214. The attention component 1208 determines how much emphasis should be placed on parts of input information when interpreting other parts of the input information. The attention component 1208 uses using the following equation to perform this analysis:

$$Attention ( Q , K , V ) = softmax ( \frac{{QK}^{T}}{\sqrt{{d}_{k}}} ) V . \qquad ( 2 )$$

The attention component 1208 produces query information Q by multiplying the embeddings 1206 by a query weighting matrix W^{Q}. Similarly, the attention component 1208 produces key information K and value information V by multiplying the embeddings 1206 by a key weighting matrix W^{K} and a value weighting matrix W^{V}, respectively. To execute Equation (2), the attention component 1208 takes the dot product of Q with the transpose of K, and then divides the dot product by a scaling factor \sqrt{d}, to produce a scaled result. The symbol d represents the dimensionality of Q and K. The attention component 1208 takes the Softmax (normalized exponential function) of the scaled result, and then multiplies the result of the Softmax operation by V, to produce attention output information. In some cases, the attention component 1208 is said to perform masked attention insofar as the attention component 1208 masks output token information that, at any given time, has not yet been determined.

Note that FIG. 12 shows that the attention component 1208 is composed of plural attention heads, including a representative attention head 1216. Each attention head performs the computations specified by Equation (2), but with respect to a particular representational subspace that is different than the subspaces of the other attention heads. To accomplish this operation, the attention heads perform the computations described above using different respective sets of query, key, and value weight matrices. Although not shown, the attention component 1208 concatenates the output results of the attention component's separate attention heads, and then multiplies the results of this concatenation by another weight matrix W^{O}.

The add-and-normalize component 1210 includes a residual connection that combines (e.g., sums) input information fed to the attention component 1208 with the output information generated by the attention component 1208. The add-and-normalize component 1210 then normalizes the output information generated by the residual connection, e.g., by layer-normalizing values in the output information based on the mean and standard deviation of those values, or by performing root-mean-squared normalization. The other add-and-normalize component 1214 performs the same functions as the first-mentioned add-and-normalize component 1210. The FFN component 1212 transforms input information to output information using a feed-forward neural network having any number of layers.

The first transformer component 1204 produces output information 1218. A series of other transformer components (1220, . . . , 1222) perform the same functions as the first transformer component 1204, each operating on output information produced by its immediately preceding transformer component. Each transformer component uses its own level-specific set of machine-trained weights. The final transformer component 1222 in the language model 1202 produces final output information 1224.

In some implementations, a post-processing component 1226 performs post-processing operations on the final output information 1224. For example, the post-processing component 1226 performs a machine-trained linear transformation on the final output information 1224, and processes the results of this transformation using a Softmax component (not shown). The language model 1202 uses the output of the post-processing component 1226 to predict the next token in the input sequence of tokens. In some applications, the language model 1202 performs this task using a greedy selection approach (e.g., by selecting the token having the highest probability), or by using the beam search algorithm (e.g., by traversing a tree that expresses a search space of candidate next tokens).

In some implementations, the language model 1202 operates in an autoregressive manner, as indicated by the loop 1228. To operate in this way, the language model 1202 appends a predicted token to the end of the sequence of input tokens, to provide an updated sequence of tokens. The predicted token leads to the production of a new embedding 1230. In a next pass, the language model 1202 processes the updated sequence of embeddings to generate a next predicted token. The language model 1202 repeats the above process until it generates a specified stop token.

The above-described implementation of the language model 1202 relies on a decoder-only architecture. Other implementations of the language model 1202 use an encoder-decoder transformer-based architecture. Here, a transformer-based decoder receives encoder output information produced by a transformer-based encoder, together with decoder input information. The encoder output information specifically includes KV information that serves an input to the attention components of the decoder (except the first transformer component).

Other implementations of the language model 1202 use other kinds of machine-trained models besides, or in addition to, the particular transformer-based architecture shown in FIG. 12. The other machine-trained models include any of convolutional neural networks (CNNs), recurrent neural networks (RNNs), other types of feed-forward neural networks (FFNS), diffusion models, selective state space models (e.g., Mamba models), etc., or any combination thereof.

### D. Illustrative Processes

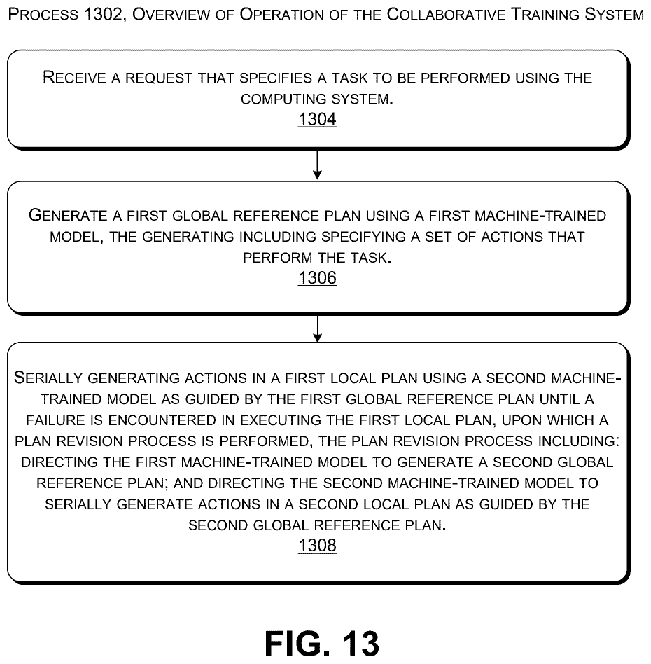

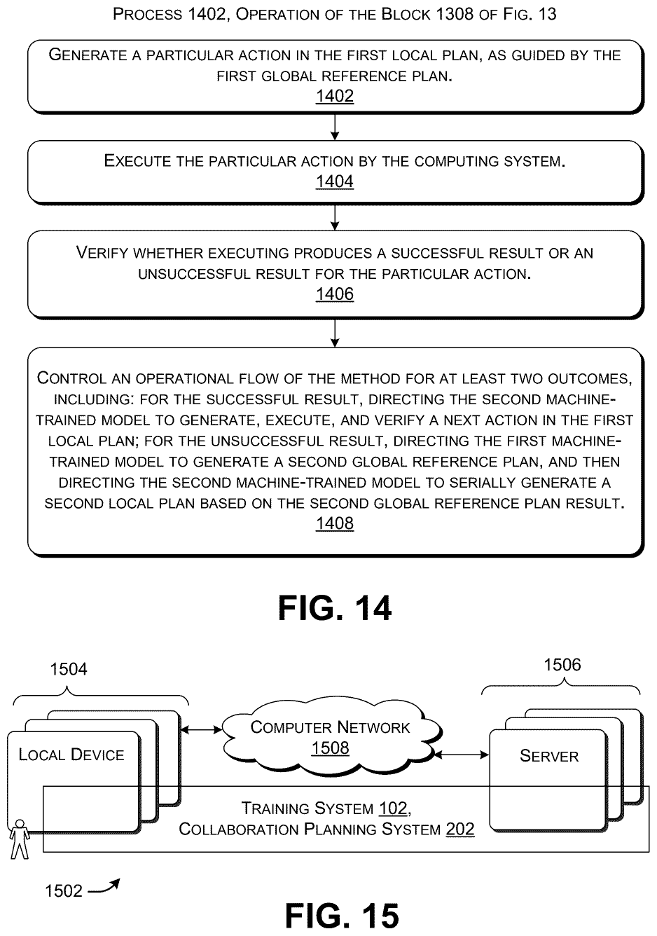

FIGS. 13 and 14 are processes that represent an overview of the operation of the collaborative planning system 202 of FIGS. 2 and 3. Each of the processes is expressed as a series of operations performed in a particular order. But the order of these operations is merely representative, and the operations are capable of being varied in other implementations. Further, any two or more operations described below are capable of being performed in a parallel manner. In one implementation, the blocks shown in the processes that pertain to processing-related functions are implemented by the computing equipment described in connection with FIGS. 15 and 16.

More FIG. 13 shows a process 1302 for generating and executing a plan. In block 1304, the collaborative planning system 202 receives a request that specifies a task to be performed using the computing system. In block 1306, the collaborative planning system 202 generates a first global reference plan using a first machine-trained model (e.g., the global planning model 704), the generating including specifying a set of actions that perform the task. In block 1308, the collaborative planning system 202 serially generates actions in a first local plan using a second machine-trained model (e.g., the local planning model 804) as guided by the first global reference plan until a failure is encountered in executing the first local plan, at which point a plan revision process is performed. The plan revision process includes: directing the first machine-trained model to generate a second global reference plan; and directing the second machine-trained model to serially generate actions in a second local plan as guided by the second global reference plan.

FIG. 14 shows a process 1402 for performing block 1308 of FIG. 13. In block 1404, the collaborative planning system 202 generates a particular action in the first local plan, as guided by the first global reference plan. In block 1406, the collaborative planning system 202 executes the particular action by the computing system. In block 1408, the collaborative planning system 202 verifies whether the executing produces a successful result or an unsuccessful result for the particular action. In block 1410, the collaborative planning system 202 performs the plan revision process for an unsuccessful result. More specifically, block 1410 includes controlling an operational flow of the method for at least two outcomes, including: for the successful result, directing the second machine-trained model to generate, execute, and verify a next action in the first local plan; for the unsuccessful result, directing the first machine-trained model to generate a second global reference plan, and then directing the second machine-trained model to serially generate a second local plan based on the second global reference plan.

### E. Illustrative Computing Systems

FIG. 15 shows computing equipment 1502 that, in some implementations, is used to implement the collaborative planning system 202 and/or the training system 316. The computing equipment 1502 includes a set of local devices 1504 coupled to a set of servers 1506 via a computer network 1508. Each local device corresponds to any type of computing device, including any of a desktop computing device, a laptop computing device, a handheld computing device of any type (e.g., a smartphone or a tablet-type computing device), a mixed reality device, an intelligent appliance, a wearable computing device (e.g., a smart watch), an Internet-of-Things (IoT) device, a gaming system, an immersive “cave,” a media device, a vehicle-borne computing system, any type of robot computing system, a computing system in a manufacturing system, etc. In some implementations, the computer network 1508 is implemented as a local area network, a wide area network (e.g., the Internet), one or more point-to-point links, or any combination thereof.

The bottom-most overlapping box in FIG. 15 indicates that the functionality of the collaborative planning system 202 and/or the training system 316 is capable of being spread across the local devices 1504 and/or the servers 1506 in any manner. In one example, the collaborative planning system 202 is entirely implemented by a local device. In another example, the functions of the collaborative planning system 202 are entirely implemented by the servers 1506. Here, a user is able to interact with the servers 1506 via a browser application running on a local device. In other examples, some of the functions of the collaborative planning system 202 are implemented by a local device, and other functions of the collaborative planning system 202 are implemented by the servers 1506. In some implementations, for instance, the global and local planning models (706, 806) are implemented by the servers 1506, and the remainder of the functions of the collaborative planning system 202 are implemented by each local device. Likewise, the training systems 316 can be implemented entirely by a local device, entirely by a server system, or by functionality provided at both a local device and a server system.

FIG. 16 shows a computing system 1602 that, in some implementations, is used to implement any aspect of the mechanisms set forth in the above-described figures. For instance, in some implementations, the type of computing system 1602 shown in FIG. 16 is used to implement any local computing device or any server shown in FIG. 15. In all cases, the computing system 1602 represents a physical and tangible processing mechanism.

The computing system 1602 includes a processing system 1604 including one or more processors. The processor(s) include one or more central processing units (CPUs), and/or one or more graphics processing units (GPUs), and/or one or more application specific integrated circuits (ASICs), and/or one or more neural processing units (NPUs), and/or one or more tensor processing units (TPUs), etc. More generally, any processor corresponds to a general-purpose processing unit or an application-specific processor unit.

The computing system 1602 also includes computer-readable storage media 1606, corresponding to one or more computer-readable media hardware units. The computer-readable storage media 1606 retains any kind of information 1608, such as machine-readable instructions, settings, model weights, and/or other data. In some implementations, the computer-readable storage media 1606 includes one or more solid-state devices, one or more hard disks, one or more optical disks, etc. Any instance of the computer-readable storage media 1606 represents a fixed or removable unit of the computing system 1602. Further, any instance of the computer-readable storage media 1606 provides volatile and/or non-volatile retention of information. The specific term “computer-readable storage medium” or “storage device” expressly excludes propagated signals per se in transit; a computer-readable storage medium or storage device is “non-transitory” in this regard.

The computing system 1602 utilizes any instance of the computer-readable storage media 1606 in different ways. For example, in some implementations, any instance of the computer-readable storage media 1606 represents a hardware memory unit (such as random access memory (RAM)) for storing information during execution of a program by the computing system 1602, and/or a hardware storage unit (such as a hard disk) for retaining/archiving information on a more permanent basis. In the latter case, the computing system 1602 also includes one or more drive mechanisms 1610 (such as a hard drive mechanism) for storing and retrieving information from an instance of the computer-readable storage media 1606.

In some implementations, the computing system 1602 performs any of the functions described above when the processing system 1604 executes computer-readable instructions stored in any instance of the computer-readable storage media 1606. For instance, in some implementations, the computing system 1602 carries out computer-readable instructions to perform each block of the processes described with reference to FIGS. 15 and 16. FIG. 16 generally indicates that hardware logic circuitry 1612 includes any combination of the processing system 1604 and the computer-readable storage media 1606.

In addition, or alternatively, the processing system 1604 includes one or more other configurable logic units that perform operations using a collection of logic gates, such as field-programmable gate arrays (FPGAs), etc. In these implementations, the processing system 1604 effectively incorporates a storage device that stores computer-readable instructions, insofar as the configurable logic units are configured to execute the instructions and therefore embody or store these instructions.

In some cases (e.g., in the case in which the computing system 1602 represents a user computing device), the computing system 1602 also includes an input/output interface 1614 for receiving various inputs (via input devices 1616), and for providing various outputs (via output devices 1618). Illustrative input devices include a keyboard device, a mouse input device, a touchscreen input device, a digitizing pad, one or more static image cameras, one or more video cameras, one or more depth camera systems, one or more microphones, a voice recognition mechanism, any position-determining devices (e.g., GPS devices), any movement detection mechanisms (e.g., accelerometers and/or gyroscopes), etc. In some implementations, one particular output mechanism includes a display device 1620 and an associated graphical user interface presentation (GUI) 1622. The display device 1620 corresponds to a liquid crystal display device, a light-emitting diode display (LED) device, a cathode ray tube device, a projection mechanism, etc. Other output devices include a printer, one or more speakers, a haptic output mechanism, an archival mechanism (for storing output information), etc. In some implementations, the computing system 1602 also includes one or more network interfaces 1624 for exchanging data with other devices via one or more communication conduits 1626. One or more communication buses 1628 communicatively couple the above-described units together.

The communication conduit(s) 1626 is implemented in any manner, e.g., by a local area computer network, a wide area computer network (e.g., the Internet), point-to-point connections, or any combination thereof. The communication conduit(s) 1626 include any combination of hardwired links, wireless links, routers, gateway functionality, name servers, etc., governed by any protocol or combination of protocols.

FIG. 16 shows the computing system 1602 as being composed of a discrete collection of separate units. In some cases, the collection of units corresponds to discrete hardware units provided in a computing device chassis having any form factor. FIG. 16 shows illustrative form factors in its bottom portion. In other cases, the computing system 1602 includes a hardware logic unit that integrates the functions of two or more of the units shown in FIG. 16. For instance, in some implementations, the computing system 1602 includes a system on a chip (SoC or SOC), corresponding to an integrated circuit that combines the functions of two or more of the units shown in FIG. 16.

The following summary provides a set of illustrative examples of the technology set forth herein.
(A1) According to one illustrative aspect, a method (e.g., the processes 1302 and 1402) is described for generating a plan for execution on a computing system. The method includes: receiving (e.g., in block 1304) a request that specifies a task to be performed using the computing system; generating (e.g., in block 1306) a first global reference plan using a first machine-trained model (e.g., the global planning model 706), the generating including specifying a set of actions that perform the task; and serially generating (e.g., in block 1308) a first local plan using a second machine-trained model (e.g., the local planning model 806). The generating includes: generating (e.g., in block 1402) a particular action in the first local plan, as guided by the first global reference plan; executing (e.g., in block 1404) the particular action by the computing system; verifying (e.g., in block 1406) whether the executing produces a successful result or an unsuccessful result for the particular action; controlling (e.g., in block 1408) an operational flow of a program that implements for at least two outcomes. The controlling includes: for the successful result, directing the second machine-trained model to generate, execute, and verify a next action in the first local plan; for the unsuccessful result, directing the first machine-trained model to generate a second global reference plan, and then directing the second machine-trained model to serially generate a second local plan based on the second global reference plan.
(A2) According to illustrative aspects of A1, the first machine-trained model is a first language model that is trained to produce global reference plans, and the second machine-trained model is a second language model that is trained to serially produce local plans.
(A3) According to illustrative aspects of A1 or A2, the request specifies the task in textual form.
(A4) According to illustrative aspects of A3, the request is accompanied by context information extracted from a screenshot presented by the computing device.
(A5) According to illustrative aspects of any of A1-A4, the first machine-trained model is trained to generate the first global reference plan by identifying one or more sub-goals in the first global reference plan, and then identifying one or more actions to be performed within each of the one or more sub-goals.
(A6) According to illustrative aspects of any of A1-A5, the first machine-trained model and the second machine-trained model are implemented by the computing system which performs execution of actions in the plan.
(A7) According to illustrative aspects of any of A1-A6, the particular action that is generated by the second machine-trained model is a first action in the first local plan, and wherein the second machine-trained model chooses a first action in the first global reference plan as the first action in the first local plan.
(A8) According to illustrative aspects of any of A1-A6, in generating the particular action in the first local plan, the second machine-trained model assigns a prescribed preference to a counterpart action suggested by the first global reference plan, wherein the second machine-trained model deviates from the counterpart action when another action is determined to have a higher preference than the prescribed preference.
(A9) According to illustrative aspects of any of A1-A8, in serially generating actions in the second local plan after failure of the first local plan, the second machine-trained model begins with a first action of the task.
(A10) According to illustrative aspects of any of A1-A8, in serially generating actions in the second local plan after failure of the first local plan, the second machine-trained model begins at a point of execution at which the first local plan has failed.
(A11) According to illustrative aspects of any of A1-A10, in generating the particular action in the first local plan, the second machine-trained model performs a grounding check, wherein the grounding check provides one or more values that will guide selection and execution of the particular action.
(A12) According to illustrative aspects of A11, the one or more values specify a location which at which a graphical element involved in execution of the particular action is presented on a user interface presentation.
(A13) According to illustrative aspects of any of A1-A12, the verifying includes determining that the first local plan has encountered a processing loop that fails to advance towards completion of the task.
(B1) According to another illustrative aspect, a method (e.g., the process 1302) is described for generating and executing a plan. The method includes: receiving (e.g., in block 1304) a request that specifies a task to be performed using the computing system; generating (e.g., in block 1306) a first global reference plan using a first machine-trained model (e.g., the global planning model 704), the generating including specifying a set of actions that perform the task; and serially generating (e.g., in block 1306) actions in a first local plan using a second machine-trained model (e.g., the local planning model 806) as guided by the first global reference plan until a failure is encountered in executing the first local plan, upon which a plan revision process is performed. The plan revision process includes: directing the first machine-trained model to generate a second global reference plan; and directing the second machine-trained model to serially generate actions in a second local plan as guided by the second global reference plan.

In yet another aspect, some implementations of the technology described herein include a computing system (e.g., the computing system 1602) that includes a processing system (e.g., the processing system 1604) having a processor. The computing system also includes a storage device (e.g., the computer-readable storage media 1606) for storing computer-readable instructions (e.g., the information 1608). The processing system executes the computer-readable instructions to perform any of the methods described herein (e.g., any individual method of the methods of A1-A13 and B1).

In yet another aspect, some implementations of the technology described herein include a computer-readable storage medium (e.g., the computer-readable storage media 1606) for storing computer-readable instructions (e.g., the information 1608). A processing system (e.g., the processing system 1604) executes the computer-readable instructions to perform any of the operations described herein (e.g., the operations in any individual method of the methods of A1-A13 and B1).

More generally stated, any of the individual elements and steps described herein are combinable into any logically consistent permutation or subset. Further, any such combination is capable of being manifested as a method, device, system, computer-readable storage medium, data structure, article of manufacture, graphical user interface presentation, etc. The technology is also expressible as a series of means-plus-format elements in the claims, although this format should not be considered to be invoked unless the phrase “means for” is explicitly used in the claims.

This description may have identified one or more features as optional. This type of statement is not to be interpreted as an exhaustive indication of features that are to be considered optional; generally, any feature is to be considered as an example, although not explicitly identified in the text, unless otherwise noted. Further, any features described as alternative ways of carrying out identified functions or implementing identified mechanisms are also combinable together in any combination, unless otherwise noted.

In terms of specific terminology, the phrase “configured to” encompasses various physical and tangible mechanisms for performing an identified operation. The mechanisms are configurable to perform an operation using the hardware logic circuitry 1612 of FIG. 16. The term “logic” likewise encompasses various physical and tangible mechanisms for performing a task. For instance, each processing-related operation illustrated in the flowcharts of FIGS. 13 and 14 corresponds to a logic component for performing that operation.

Further, the term “plurality” or “plural” or the plural form of any term (without explicit use of “plurality” or “plural”) refers to two or more items, and does not necessarily imply “all” items of a particular kind, unless otherwise explicitly specified. The term “at least one of” refers to one or more items; reference to a single item, without explicit recitation of “at least one of” or the like, is not intended to preclude the inclusion of plural items, unless otherwise noted. Further, the descriptors “first,” “second,” “third,” etc. are used to distinguish among different items, and do not imply an ordering among items, unless otherwise noted. The phrase “A and/or B” means A, or B, or A and B. The phrase “any combination thereof” refers to any combination of two or more elements in a list of elements. Further, the terms “comprising,” “including,” and “having” are open-ended terms that are used to identify at least one part of a larger whole, but not necessarily all parts of the whole. A “set” is a group that includes one or more members. The phrase “A corresponds to B” means “A is B” in some contexts. The term “prescribed” is used to designate that something is purposely chosen according to any environment-specific considerations. For instance, a threshold value or state is said to be prescribed insofar as it is purposely chosen to achieve a desired result. “Environment-specific” means that a state is chosen for use in a particular environment. Finally, the terms “exemplary” or “illustrative” refer to one implementation among potentially many implementations.

In closing, the functionality described herein is capable of employing various mechanisms to ensure that any user data is handled in a manner that conforms to applicable laws, social norms, and the expectations and preferences of individual users. For example, the functionality is configurable to allow a user to expressly opt in to (and then expressly opt out of) the provisions of the functionality. The functionality is also configurable to provide suitable security mechanisms to ensure the privacy of the user data (such as data-sanitizing mechanisms, encryption mechanisms, and/or password-protection mechanisms).

Further, the description may have set forth various concepts in the context of illustrative challenges or problems. This manner of explanation is not intended to suggest that others have appreciated and/or articulated the challenges or problems in the manner specified herein. Further, this manner of explanation is not intended to suggest that the subject matter recited in the claims is limited to solving the identified challenges or problems; that is, the subject matter in the claims may be applied in the context of challenges or problems other than those described herein.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A method for generating a plan for execution on a computing system, comprising:
receiving a request that specifies a task to be performed using the computing system;
generating a first global reference plan using a first machine-trained model, the generating including specifying a set of actions that perform the task;
serially generating a first local plan using a second machine-trained model by:
generating a particular action in the first local plan, as guided by the first global reference plan;
executing the particular action by the computing system;
verifying whether the executing produces a successful result or an unsuccessful result for the particular action;
controlling an operational flow of the method using a program that implements at least two outcomes, including: for the successful result, directing the second machine-trained model to generate, execute, and verify a next action in the first local plan; for the unsuccessful result, directing the first machine-trained model to generate a second global reference plan, and then directing the second machine-trained model to serially generate a second local plan based on the second global reference plan.

2. The method of claim 1, wherein the first machine-trained model is a first language model that is trained to produce global reference plans, and wherein the second machine-trained model is a second language model that is trained to serially produce local plans.

3. The method of claim 1, wherein the request specifies the task in textual form.

4. The method of claim 3, wherein the request is accompanied by context information extracted from a screenshot presented by the computing device.

5. The method of claim 1, wherein the first machine-trained model is trained to generate the first global reference plan by identifying one or more sub-goals in the first global reference plan, and then identifying one or more actions to be performed within each of the one or more sub-goals.

6. The method of claim 1, wherein the first machine-trained model and the second machine-trained model are implemented by the computing system which performs execution of actions in the plan.

7. The method of claim 1, wherein the particular action that is generated by the second machine-trained model is a first action in the first local plan, and wherein the second machine-trained model chooses a first action in the first global reference plan as the first action in the first local plan.

8. The method of claim 1, wherein, in generating the particular action in the first local plan, the second machine-trained model assigns a prescribed preference to a counterpart action suggested by the first global reference plan, wherein the second machine-trained model deviates from the counterpart action when another action is determined to have a higher preference than the prescribed preference.

9. The method of claim 1, wherein, in serially generating actions in the second local plan after failure of the first local plan, the second machine-trained model begins with a first action of the task.

10. The method of claim 1, wherein, in serially generating actions in the second local plan after failure of the first local plan, the second machine-trained model begins at a point of execution at which the first local plan has failed.

11. The method of claim 1, wherein, in generating the particular action in the first local plan, the second machine-trained model performs a grounding check, wherein the grounding check provides one or more values that will guide selection and execution of the particular action.

12. The method of claim 11, wherein, the one or more values specify a location which at which a graphical element involved in execution of the particular action is presented on a user interface presentation.

13. The method of claim 1, wherein the verifying includes determining that the first local plan has encountered a processing loop that fails to advance towards completion of the task.

14. A computing system for generating and executing a plan, comprising:
an instruction data store for storing computer-readable instructions; and
a processing system for executing the computer-readable instructions in the data store, to perform operations including:
receiving a request that specifies a task to be performed using the computing system;
generating a first global reference plan using a first machine-trained model, the generating including specifying a set of actions that perform the task; and
serially generating actions in a first local plan using a second machine-trained model as guided by the first global reference plan until a failure is encountered in executing the first local plan, upon which a plan revision process is performed, the plan revision process including: directing the first machine-trained model to generate a second global reference plan; and directing the second machine-trained model to serially generate actions in a second local plan as guided by the second global reference plan.

15. The computing system of claim 14, wherein the serially generating the actions in the first local plan includes:
generating a particular action in the first local plan, as guided by the first global reference plan;
executing the particular action by the computing system;
verifying whether the executing produces a successful result or an unsuccessful result for the particular action; and
performing the plan revision process for an unsuccessful result.

16. The computing system of claim 15, wherein the particular action that is generated by the second machine-trained model is a first action in the first local plan, and wherein the second machine-trained model chooses a first action in the first global reference plan as the first action in the first local plan.

17. The computing system of claim 15, wherein, in generating the particular action, the second machine-trained model assigns a prescribed preference to a counterpart action suggested by the first global reference plan, wherein the second machine-trained model deviates from the counterpart action when another action is determined to have a higher preference than the prescribed preference.

18. The computing system of claim 15, wherein the verifying includes determining that the first local plan has encountered a processing loop that fails to advance towards completion of the task.

19. A computer-readable storage medium for storing computer-readable instructions, a processing system executing the computer-readable instructions to perform operations, the operations comprising each of:
receiving a request that specifies a task to be performed using a computing system; and
generating and executing actions to carry out the task by collaborative interaction of a first machine-trained model and a second machine-trained model,
the first machine-trained model being trained to generate a first global reference plan that specifies a complete set of actions to perform the task, and
the second machine-trained model being trained to serially generate actions in a first local plan as guided by the first global reference plan until a failure is encountered in executing the first local plan, upon which:
the first machine-trained model is directed to generate a second global reference plan; and
the second machine-trained model is directing to serially generate actions in a second local plan as guided by the second global reference plan.

20. The computer-readable storage medium of claim 19, wherein failure of the first local plan occurs when a processing loop is encountered that fails to advance towards completion of the task.
